(19) United States
(12) Patent Application Publication
(10) Pub. No.: US 2022/0172258 A1
(43) Pub. Date: Jun. 2, 2022

(54) ARTIFICIAL INTELLIGENCE-BASED PRODUCT DESIGN

(71) Applicant: ACCENTURE GLOBAL SOLUTIONS LIMITED, Dublin (IE)

(72) Inventors: Prateek JAIN, Delhi (IN); Mamta Aggarwal RAJNAYAK, New Delhi (IN); Neha DIXIT, Gurugram (IN); Govindarajan JOTHIKUMAR, Bangalore (IN)

(73) Assignee: ACCENTURE GLOBAL SOLUTIONS LIMITED, Dublin (IE)

(21) Appl. No.: 17/105,953

(22) Filed: Nov. 27, 2020

(51) Int. Cl. G06Q 30/02; G06Q 30/06; G06Q 10/06; G06F 40/117; G06N 20/00

(52) U.S. Cl. CPC G06Q 30/0282; G06Q 30/0201; G06Q 30/0202; G06N 20/00; G06Q 30/0621; G06Q 10/06393; G06F 40/117; G06Q 30/0631

(57) ABSTRACT

A system for providing real-time optimized product designs may obtain historical data and real-time data related to a product to identify real-time customer preferences and sentiments associated with the product. The system may provide a plurality of real-time potential attribute recommendations comprising attributes likely to be preferred by customers. The system may provide a set of preferred attribute recommendations based on the plurality of real-time potential attribute recommendations ranked highest in an attribute ranking order. The system may provide a cannibalization factor and a similarity index for each of the set of preferred attribute recommendations. The system may provide a real-time demand forecast of the product and may also provide a predicted cannibalization volume and a predicted incremental volume for the product in real-time. The system may determine a set of final attribute recommendations for the product to provide an optimized design for the product in real-time.

### BACKGROUND

Generally, significant consumer research, design iteration, market segmentation, and market testing is carried out to develop and launch a new product or an enhanced version of an existing product. To achieve desired results, an organization usually incurs significant expenditure on such endeavors. In addition, the lead time involved in research and development of a product can easily stretch to months and, in some cases, even years. Moreover, even after spending a substantial amount of time and money on the research and development, there is no assurance of product profitability after the product is launched in the market. There may be numerous reasons due to which a product may not be well received by consumers even after carrying out extensive market research before launching the product.

Conventionally, consumer research is carried out with a limited number of existing alternatives, wherein a consumer's preference is gauged based on limited number of features or attributes that already exist in the market for a product. Additionally, it is also assumed that a consumer preference will remain unchanged till the product is launched. However, in many cases, it is common that a consumer's reaction towards one attribute of a product differs from the consumer's initial reaction to the attribute. For example, it is common for a person to initially prefer, during the research, a mobile phone with good quality camera and long lasting battery, only to change his/her mind later and prefer faster processing speed and plenty of storage space, by the time the product is launched. In other words, the conventional systems and methods for designing or enhancing a product may not consider rapidly changing trends and preferences and, therefore, may not achieve expected product profitability.

Accordingly, a technical problem with the currently available product designing systems is that they do not consider real-time consumer preferences, sentiments, and current trends to provide real-time product design recommendations. In addition, the conventional product designing systems do not provide accurate forecast volume. The conventional product designing systems also fail to take into account real-time cannibalization volume for products with new or partially new design features, the cannibalization volume being indicative of volume of sales that may be lost because a similar product already exists in the market. Accordingly, the conventional product designing techniques may lead to heavy losses, not only in monetary terms, but also in terms of critical resources such as time and manpower. Therefore, convention product designing techniques can be found to be deficient in providing an efficient and effective manner of arriving at a new product design. Therefore, there is a need for a product designing system that provides real-time optimized design recommendations backed by a robust data-driven approach. In addition, there is a need for a product designing system that automatically reconfigures portions of a client's system in real-time based on the real-time optimized design recommendations to obtain an optimal product that complements consumer expectations.

### BRIEF DESCRIPTION OF DRAWINGS

The illustrated embodiments of the present disclosure will be best understood by reference to the drawings, wherein like parts are designated by like numerals throughout. The following description is intended only by way of example, and simply illustrates certain selected embodiments of devices, systems, and processes that are consistent with the present disclosure as claimed herein.

FIG. 1 illustrates an architecture diagram of a system for providing real-time optimized product designs, according to an example embodiment of the present disclosure.

FIGS. 2A and 2B illustrate an example implementation of an attribute analyzer for obtaining clean data, according to an example embodiment of the present disclosure.

FIGS. 3 and 4 illustrate example implementations of the attribute analyzer for providing real-time potential attribute recommendations, according to an example embodiment of the present disclosure.

FIGS. 5A and 5B illustrate example implementations of an attribute modeler for obtaining a composite variable and creating batches, according to an example embodiment of the present disclosure.

FIGS. 6A and 6B illustrate example implementations of the attribute modeler for obtaining an attribute composite score, according to an example embodiment of the present disclosure.

FIG. 7 illustrates an example implementation of a cannibalization factor and similarity index identifier for obtaining a cannibalization factor, according to an example embodiment of the present disclosure.

FIGS. 8A and 8B illustrate example implementations of the cannibalization factor and similarity index identifier for obtaining a similarity index, according to an example embodiment of the present disclosure,

FIGS. 9A and 9B illustrate example implementations of a capacity forecasting planner for obtaining real-time demand forecast, according to an example embodiment of the present disclosure.

FIGS. 10A and 10B illustrate process flowcharts of the capacity forecasting planner and a model predictor, according to an example embodiment of the present disclosure.

FIG. 11 illustrates a hardware platform for the implementation of the system for providing real-time optimized product design, according to an example embodiment of the present disclosure.

FIGS. 12A, 12B and 12C illustrate a process flowchart for providing real-time optimized product design, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being done or considered.

The present disclosure describes a system and method for providing optimized product designs based on artificial intelligence (AI). The system for providing an optimized design for a product (referred to as “system” hereinafter) may be used to identify in real-time, changing trends, sentiments, and preferences of customers in relation to the product, and provide real-time recommendations of attributes associated to the product that are most preferred by customers. The system may provide real-time attribute recommendations for the product based on historical and real-time data including historical and real-time customer preferences and sentiments related to the product, obtained from a plurality of data sources such as social media platforms, search engines, websites, applications, geo location services, and transaction and product data repositories.

The present system may provide a similarity index for the product, which may determine incremental volume, cannibalization volume and total volume of the product with partial or entirely a new combination of attributes. The incremental volume may indicate volume of positive impact by sale of a new product if the new product is designed using the real-time recommended attributes. The cannibalization volume may indicate volume of negative impact on sale of existing products if the new product is designed using the real-time recommended attributes. The present system may predict cannibalization volume and incremental volume for existing products as well as a new products with no, partial or entirely new combination of attributes. Consequently, the present system may identify areas of improvements and possible innovations to obtain an optimized product design. The present system may then be coupled to a client system to automatically reconfigure portions of the client system in real-time based on the real-time attribute recommendations to provide an optimally designed product.

The system of present disclosure may include, among other components, a processor, and a product design optimizer coupled to the processor. The product design optimizer may recommend in real-tune, a design for a product. The product design optimizer may include an attribute analyzer, an attribute modeler, a cannibalization factor and similarity index identifier, a capacity forecasting planner, a model predictor, and an insights generator.

The attribute analyzer may identify the product from a product portfolio including a plurality of similar products. The attribute analyzer may then obtain historical data and real-time data related to the product from a plurality of data sources. The historical data and the real-time data may include data related to a plurality of attributes of the product. The plurality of attributes may include a plurality of primary attributes, and each of the plurality of primary attributes may include a plurality of secondary attributes. The attribute analyzer may identify real-time customer preferences and sentiments associated with the product based on the obtained historical data and real-time data, to provide a plurality of real-time potential attribute recommendations comprising attributes likely to be preferred by customers. The plurality of real-time potential attribute recommendations may be provided based on the obtained historical data and the real time data, and the real-time customer preferences and sentiments.

The attribute modeler may provide an attribute composite score for each of the plurality of real-time potential attribute recommendations, to indicate an attribute ranking order of the plurality of real-time potential attribute recommendations. The attribute modeler may then provide a set of preferred attribute recommendations comprising the plurality of real-time potential attribute recommendations ranked highest in the attribute ranking order.

The cannibalization factor and similarity index identifier may provide for each of the set of preferred attribute recommendations, a cannibalization factor to indicate impact of each of the set of preferred attribute recommendations on sale of the plurality of similar product. The cannibalization factor and similarity index identifier may also provide for each of set of preferred attribute recommendations, a similarity index to indicate similarity between each of set of preferred attribute recommendations and a set of existing attributes associated to the plurality of similar products.

The capacity forecasting planner may obtain real-time and historical time series data related to the plurality of similar products. The capacity forecasting planner may then create an ensemble model using the real-time and historical time series data to provide a composite volume for each of the plurality of similar products, indicating a real-time demand forecast of the product.

The model predictor may provide in real-time a predicted cannibalization volume for the product based on the cannibalization factor, and a predicted incremental volume for the product, based on the predicted cannibalization volume and the composite volume. The predicted cannibalization volume may predict impact of sale of the product having the set of preferred attribute recommendations, on the sale of the plurality of similar products, and the predicted incremental volume may predict future sale volume of the product having the set of preferred attribute recommendations,

The insights generator may determine, in real-time, a set of final attribute recommendations for the product, from the set of preferred attribute recommendations, to provide in real-time, an optimized design for the product.

The embodiments for the present system herein are exemplary in nature and should be treated as such. For the sake of brevity and technical clarity, the description of the system for providing an optimized design for a product may be restricted to few exemplary embodiments, however, to a person of ordinary skill in the art, it should be clear that the system may be used for the fulfillment of various product design optimization requirements other than those mentioned hereinafter.

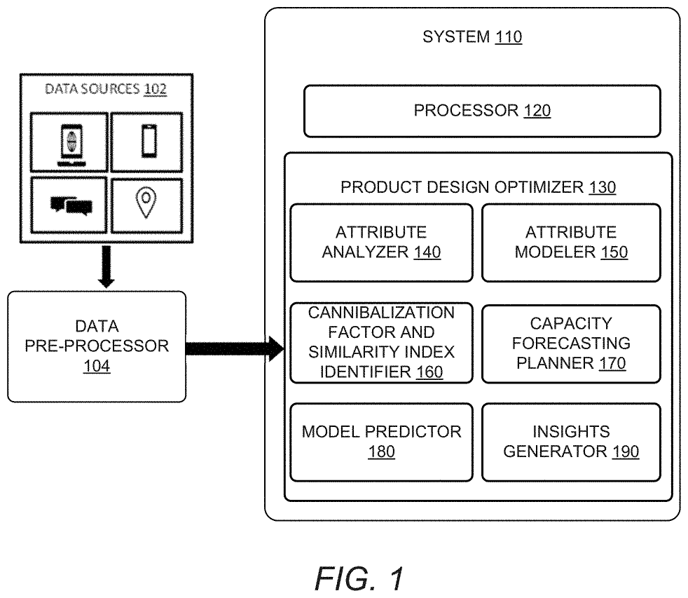

FIG. 1 illustrates an architecture diagram 100 of a system for providing real-time optimized product designs 110 (referred to as system 110 hereinafter). The system 110 may identify real-time customer sentiments, preferences and trends related to a product and may provide a detailed analysis to eventually identify area of improvements and/or possible innovations in the product to provide an optimized product design. The product may be associated with a plurality of attributes including a plurality of primary attributes. The primary attributed may include a plurality of secondary attributes.

For example, if the product is a shirt, the primary attributes associated with the ‘shirt’ may be color, material, size etc., and the secondary attributes associated with the primary attribute ‘color’ may be red, blue, green etc. The system 110 may be used to strategically optimize launch of any new product based on best combination of the primary attributes and the secondary attributes. The system 110 may provide optimized design for an existing product or a new product or may provide a design to partially upgrade an existing product.

In an example embodiment, if a user using the system 110 intends to launch a new mobile phone, the system 110 may identify attributes related to existing mobile phones that are in-demand and most preferred by customers. The system 110 may then identify cannibalization impact of the identified attributes on the existing mobile phones, and select attributes from the identified attributes that contribute least towards cannibalization and generate maximum incremental volume. The system 110 may also identify new attributes based on the real-time changing demands and preferences of customers and may then provide an optimized product design for the mobile phone using the selected attributes and new attributes.

In an example embodiment, the system 110 also provides product design optimization by partially upgrading designs of existing products. The system 110 may be used to provide optimized design even if the user does not wish to launch a new mobile phone and intends to partially upgrade existing mobile phones from his product portfolio.

For example, the user may have two versions of mobile phones, A1 and A2, in the product portfolio. The system 110 may identify that version A1 has a high cannibalization impact on version A2 which results into less incremental volume. Based on real-time customer feedback and changing trends, the system 110 may provide optimized designs to upgrade both versions A1 and A2 such that they result in high incremental volume and less cannibalization impact. This in turn may enable the user May to maximize revenue by reducing cost of launching an entirely new product i.e., mobile phone, and re-launching the existing products.

In an example, the system 100 may design product launch or distribution of an existing product by identifying potential cannibalization impacts and incremental volume. The user may use the system 100 to optimize product production and distribution based on forecasted demand and real time trends of different markets. The system 110 may also assist the user to locate most profitable markets for his products, by understanding real-time market insights and trends.

In order to understand real-time market insights and identify real-time customer preferences and trends related to the product, the system 110 collects real-time data related to the product from a plurality of data sources 102. The data sources 102 may provide data including macro and micro-economic data, transaction and product data, data from websites and applications, Google or social media click stream data, and geo location data, from social media platforms, search engines, websites, applications, geo location services, transaction and product data repositories, or a combination thereof. The collected real-time data is pre-processed by a data pre-processor 104 to obtain pre-processed data related to the product that may be used by the system 110 to provide an optimized design for the product.

The data pre-processor 104 may aggregate and pre-process the collected real-time data by cleaning and transforming raw collected data into a useful and understandable format to obtain pre-processed data. The pre-processed data may include data related to primary attributes and secondary attributes of the product. The data pre-processor 104 may store the pre-processed data in a server (not shown). The pre-processed data may include real-time data obtained from customers in relation to the product and historical data obtained from the customers in relation to the product. The system 110 may use the pre-processed data to identify real-time customer preferences and trends related to the product to provide an optimized design of the product. The system 110 may include, for example, a processor 120 coupled to a product design optimizer 130.

The product design optimizer 130 may provide a design for the product. The product may be a part of a product portfolio including a plurality of similar products. Similar products refer to same type of products having different attributes. For example, a product portfolio of shirts may include shirts having different attributes, like different colors, materials, sizes, styles, prices etc. The product design optimizer 130 may include an attribute analyzer 140, an attribute modeler 150, a cannibalization factor and similarity index identifier 160, a capacity forecasting planner 170, a model predictor 180, and an insights generator 190.

The attribute analyzer 140 may identify the product from the product portfolio for which a design is to be recommended. In an example, the user may provide the product which requires design recommendation. The attribute analyzer 140 may be coupled to the data pre-processor 104 to receive the pre-processed data including the historical data and the real-time data related to the attributes of the product, and pre-process the historical data and the real-time data to obtain dean data. The dean data may be then analyzed by the attribute analyzer 140 to identify real-time customer preferences and sentiments associated with the product, the primary attributes and the secondary attributes.

Based on the analysis, the attribute analyzer 140 may then identify in real-time, a set of potential attributes of the product, and map the set of potential attributes with the clean data to provide a plurality of real-time potential attribute recommendations. The set of potential attributes may include preferred primary attributes and preferred secondary attributes. The plurality of real-time potential attribute recommendations may comprise attributes likely to be preferred by customers, based on the historical data and the real time data, and the real-time customer preferences and sentiments. In an example, the attribute analyzer 140 has capacity to handle large volume of data and may capture data from multiple dimensions and platforms.

The attribute modeler 150 may be coupled to the data pre-processor 104 to obtain a historical analytical record of the product from the historical data. The attribute modeler 150 may then provide a composite variable for the product based on the historical analytical record and the plurality of real-time potential attribute recommendations. The composite variable for the product indicates attribute data related to the product in different time periods. For example, data from past 12 months including historic sales of products, percentage change of positive feedback, click counts etc., may be captured to obtain the composite variable. In an example, the composite variable is obtained using time and stratified sampling techniques. The composite variable may then be used to create a plurality of mutually exclusive attribute batches and to apply a plurality of machine learning techniques on the plurality of mutually exclusive attribute batches to provide an attribute composite score and a set of preferred attribute recommendations. The attribute composite score may be provided for each of the plurality of real-time potential attribute recommendations, to indicate an attribute ranking order of the plurality of real-time potential attribute recommendations. The set of preferred attribute recommendations may comprise the plurality of real-time potential attribute recommendations ranked highest in the attribute ranking order.

The cannibalization factor and similarity index 160 may provide for each of the set of preferred attribute recommendations, a cannibalization factor to indicate impact of each of the set of preferred attribute recommendations on sale of the plurality of similar products, a similarity index to indicate similarity between each of set of preferred attribute recommendations and a set of existing attributes associated to the plurality of similar products. The cannibalization factor and similarity index 160 may indicate similarity index for partially new products as well as entirely new products.

The capacity forecasting planner 170 may be coupled to the data pre-processor 104 to obtain real-time and historical time series data related to the similar products. Based on the obtained real-time and historical time series data, the capacity forecasting planner 170 may create an ensemble model to provide a composite volume for each of the plurality of similar products. The composite volume may indicate a real-time demand forecast of the product. Demand forecast may be used to predict future sales of the product.

The model predictor 180 may provide in real-time a predicted cannibalization volume for the product based on the cannibalization factor provided by the cannibalization factor and similarity index 160. The predicted cannibalization volume may predict impact of sale of the product having the set of preferred attribute recommendations, on the sale of the plurality of similar products. The model predictor 180 may also provide in real-time a predicted incremental volume for the product, based on the predicted cannibalization volume and the composite volume. The predicted incremental volume may predict future sale volume of the product having the set of preferred attribute recommendations.

The insights generator 190 may determine, in real-time, a set of final attribute recommendations for the product, from the set of preferred attribute recommendations. The set of final attribute recommendations may be utilized to provide in real-time, an optimized design for the product. The set of final attribute recommendations may be determined based on a set of pre-determined rules, the cannibalization volume, the similarity index, the real-time demand forecast, the predicted cannibalization volume, and the predicted incremental volume.

In an example, the set of pre-determined rules include rules for determining final attribute recommendations based on a threshold value of cannibalization factor and a threshold value of similarity index. For example, a rule may be to compare attribute composite scores related to the plurality of real-time potential attribute recommendations with a score threshold value, and select the plurality of real-time potential attribute recommendations as the preferred attribute recommendations if their attribute composite scores are above the score threshold value. Another rule may be, if the attribute composite scores are same, the preferred attribute recommendations may be selected based on volume of sales index. The volume of sales index may be generated from the attribute composite scores. In an example, a rule may be to select a particular attribute as a preferred attribute recommendation, if the similarity index for that attribute is greater than a similarity threshold value but the cannibalization factor associated to that attribute is less than a cannibalization threshold value. Therefore, the system may provide real-time optimized design recommendations for the product based on real-time customer preferences, sentiments, and current trends. However, in order to determine customer preferences, sentiments and current trends, data from external data sources needs to be cleaned by the system 110.

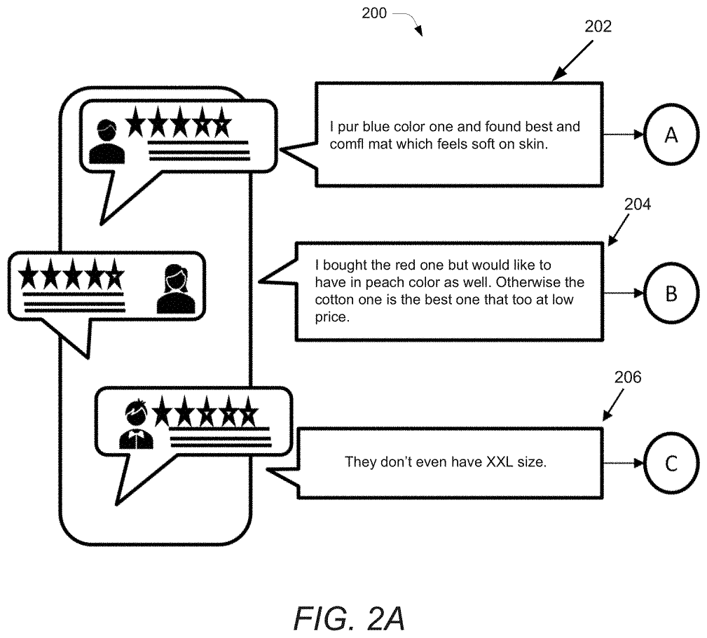

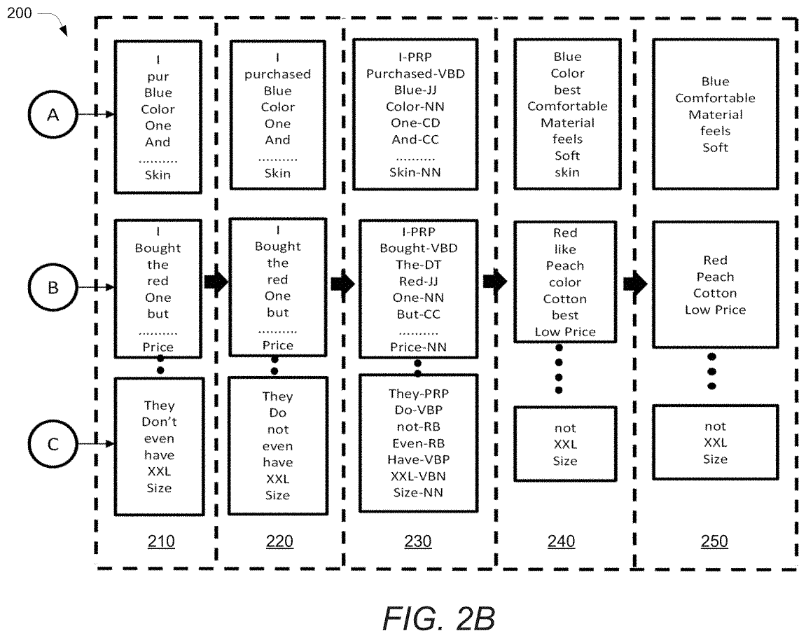

FIGS. 2A and 2B illustrate an example implementation 200 of the attribute analyzer 140 for obtaining the clean data when the data is website application data obtained from external data sources like websites and applications. Website/application data may include user feedback associated to the product. The attribute analyzer 140 may be coupled to the data pre-processor 104 to extract user feedbacks 202, 204, 206, i.e., customer reviews related the product, from the websites and applications, using web-scrapping techniques.

At block 210, the attribute analyzer 140 may use text analytics on the user feedbacks 202, 204, 206 to obtain segmented words. The text analytics may perform sentence to word segmentation on the user feedbacks 202, 204, 206. For example, if the user feedback 202 is “I pur blue color one and found best and comfl mat which feels soft on skin.”, the segmented words at the block 210 “I pur Blue Color One And Skin”. The attribute analyzer 140 may then correct spellings, slangs, abbreviations etc. by performing word correction to obtain corrected words at block 220. This process may enable the attribute analyzer 140 to avoid loss of data. Considering the same example of the user feedback 202, the corrected words may be “I purchased Blue Color One And Skin”. The attribute analyzer 140, at block 230, may then use text tokenization to tag different parts of speech in the corrected words to obtain tokenized data, and may then remove stop words like prepositions, conjunctions etc. from the tokenized data at block 240, to obtain clean data at block 250. For example, the corrected words “I purchased Blue Color One And Skin” may result in tokenized data like “I-PRP Purchased-VBD Blue-JJ Color-NN One-CD And-CC Skin-NN”. The attribute analyzer 140 may obtain “Blue Color best Comfortable Material feels Soft skin” once stop words are removed from the tokenized data, and may then finally obtain the clean data “Blue Comfortable Material feels Soft” at block 250. The attribute analyzer 140 may then analyze the clean data to identify the real-time customer preferences and sentiments associated with the product to provide the real-time potential attribute recommendations.

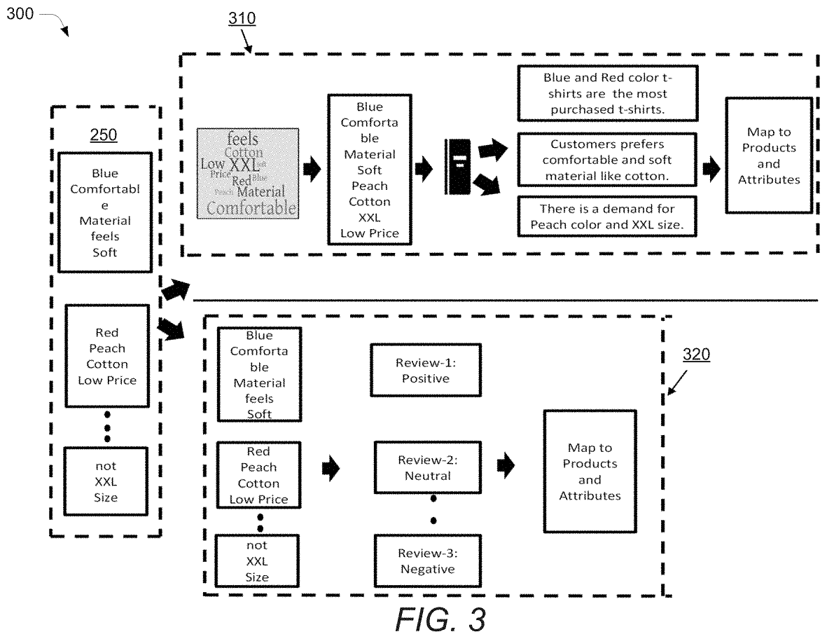

FIG. 3 illustrates an example implementation 300 of the attribute analyzer 140 for providing real-time potential attribute recommendations. The is attribute analyzer 140 may utilize the clean data obtained at block 250 to identify the real-time customer preferences and sentiments associated with the product, the plurality of primary attributes and the plurality of secondary attributes. The dean data at block 250 may be provided to an attribute recommender 310 and a sentiment analyzer 320. The attribute recommender 310 may use the clean data to update an existing word cloud to in turn identify most relevant used words.

For example, if the clean data contains “Blue Comfortable Material feels Soft Red Peach Cotton Low Price . . . not XXL Size”, the most relevant words after updating the word cloud may include “Blue Comfortable Material Soft Peach Cotton XXL Low Price”. These most relevant words may be mapped in a word corpus with existing words to identify new trends. In an example, new trend in a customer's search or feedback may be captured by using Neuro-linguistic programming (NLP) techniques and maintaining the word corpus. The word corpus may be updated with real-time data to understand the change in customer's thoughts with respect to time.

The attribute recommender 310 may then provide real-time recommendations like “Blue and Red color t-shirts are the most purchased t-shirts.”, “Customers prefers comfortable and soft material like cotton.”, and “There is a demand for Peach color and XXL size.”, based on the identified trends. These real-time recommendations may be mapped to the product and the attributes to obtain a first set of potential attributes according to customer preferences.

The sentiment analyzer 320 may use negation handling and stemming techniques on the clean data to determine emotional tone in the clean data associated to the user feedbacks. The sentiment analyzer 320 may then use techniques including bag of word, emoticons, star ratings or clustering, naive Bayes, support vector machine (SVM) to identify real-time sentiment data, i.e., sentiment behind the user feedback. For example, if the dean data is “Blue Comfortable Material feels”, the sentiment analyzer 320 may identify that the sentiment of the customer is positive, if the dean data is “Red Peach Cotton Low Price”, the sentiment is neutral, and if the dean data is “not XXL Size”, the sentiment is negative. The identified sentiment data may be mapped to the product and the attributes by the sentiment analyzer 320 to obtain a second set of potential attributes according to customer preferences.

The attribute analyzer 140 may then map the first set of potential attributes and the second set of potential attributes with the dean data to provide a plurality of red-time potential attribute recommendations based on the red-time customer preferences and sentiments. In an example, if a user feedback includes product name that matches an existing product in the product portfolio, red-time recommendations may be mapped to the existing product and associated attributes. For example, if a user feedback for product-1 from customer-1 is “I bought Product-1 and really like the material.”, it is dear from the user feedback that the customer is providing his sentiments related to product-1. In such a case, the sentiment data and red-time recommendations associated to the product may be mapped to the product. If the user feedback does not mention a specific product, the attribute analyzer 140 may use advance unsupervised techniques such as K-mean clustering and density based clustering to club similar click stream or feedback data together based on the words/attributes mentioned and map the sentiment data and real-time recommendations of customers to the attributes. Thus, data may be mapped back to the product using neuro-linguistic programming (NLP) techniques and those without any product name may be reported at attribute level by using unsupervised techniques such as K-mean clustering, and density based clustering etc., to avoid data loss.

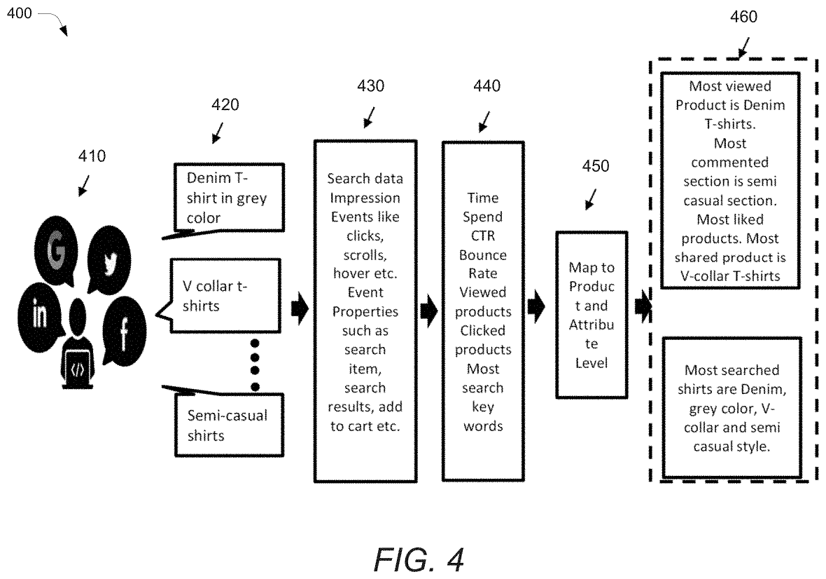

FIG. 4 illustrates an example implementation 400 of the attribute analyzer 140 for providing real-time recommendations if the extracted data is click stream data. Click stream data may be data obtained from various social media platforms 410 and may provide useful data for customer behavior and usability analysis. Customers may use the social media platforms to provide search and click data 420. The attribute analyzer 140 may, at block 430, search data impression, events like clicks, scrolls, hover etc. and event properties such as search item, search results, add to cart etc. from the extracted data.

For this, the attribute analyzer 140 may capture e-commerce, click stream and web search data at product level using cloud-based or Hadoop technology like Google analytics or Amazon Web Services (AWS). The attribute analyzer 140, at block 440, may then generate key performance indicators (KPIs) including time spend, click through rate (CTR), bounce rate, viewed products, clicked products, and most search key words from the search data. The attribute analyzer 140 may use Deep learning based pattern detection techniques and Neuro-linguistic programming (NLP) based text-mining techniques to generate the KPIs. The attribute analyzer 140 may then use click stream analytics to map the KPIs to the product and the attributes at block 450, and provide the real-time recommendations including “Most viewed Product is Denim T-shirts. Most commented section is semi casual section. Most liked products. Most shared product is V-collar T-shirts” and “Most searched shirts are Denim, grey color, V-collar and semi casual style.” at block 460. Based on the real-time recommendations, the attribute analyzer 140 may provide the real-time potential attribute recommendations comprising attributes likely to be preferred by customers. The attribute modeler 150 may use the real-time potential attribute recommendations to provide the set of preferred attribute recommendations based on the composite variable and the composite score.

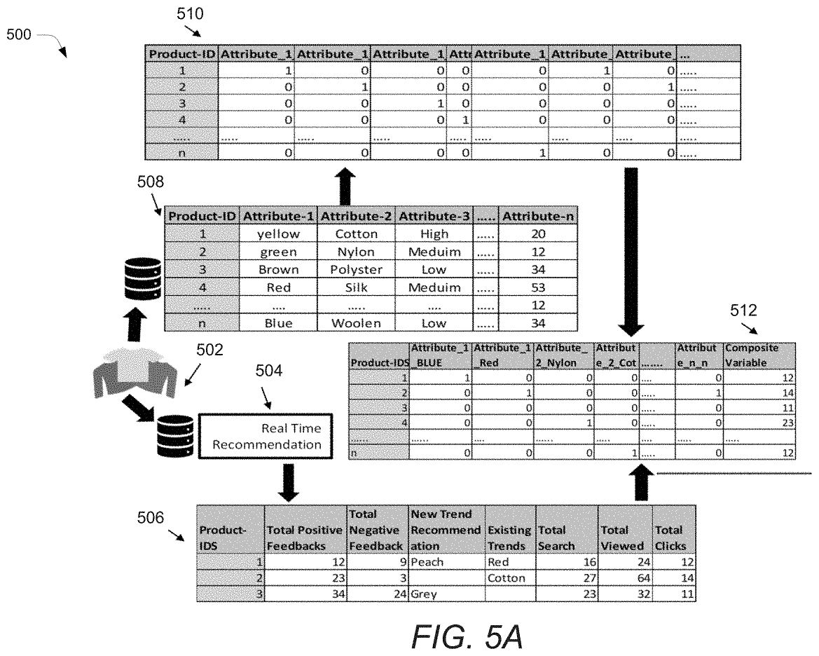

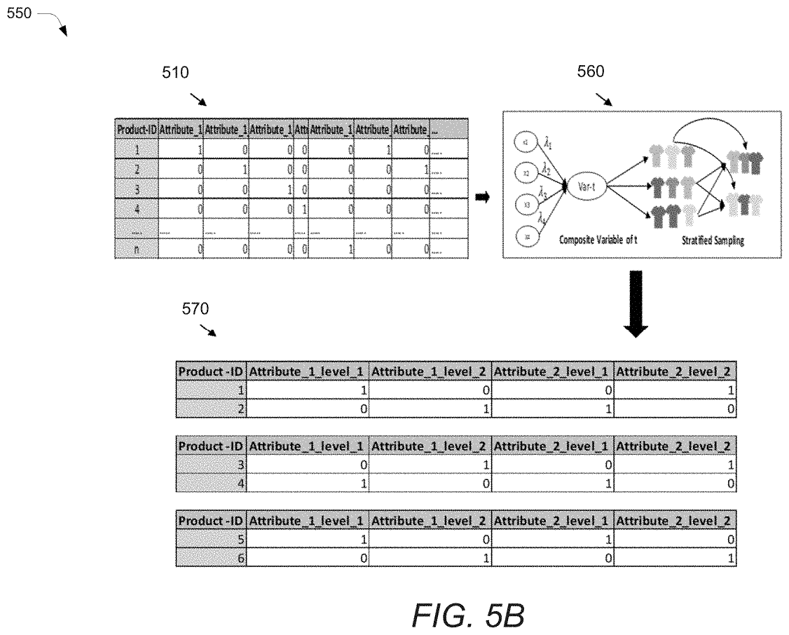

FIGS. 5A and 5B illustrate example implementations 500, 550 of the attribute modeler 150 for obtaining the composite variable and creating batches. The attribute modeler 150 may obtain the real-time potential attribute recommendations 504 from the attribute analyzer 140. The real time recommendations may be related to products from an existing product portfolio 502. The attribute modeler 150 may then map the real-time potential attribute recommendations to the products to obtain a first table 506. The first table 506 may contain real-time and historical sales and attribute recommendation data recorded at the product level or the attribute level. The first table 506 may include data, such as number of total positive and negative feedbacks, new trend recommendations, existing trends, total search, total viewed, total clicks etc.

In an example, for product-1, the table 506 may include 12 total positive feedbacks, 9 total negative feedbacks, ‘peach’ as a new trend recommendations, ‘red’ as an existing trend, 16 total searches, i.e., product-1 was searched 16 times, 24 total viewed, i.e., product-1 was viewed 24 times, and 12 total clicks, i.e., product-1 was selected/clicked on 12 times.

The attribute modeler 150 may obtain a product analytical record 508 from historical data, containing historical attribute data related to all products from the existing product portfolio 502. The product analytical record 508 may include analytical data related to the products. For example, the product analytical record for product-1 may include data related to different attributes associated with product-1 like attribute-1 ‘yellow’, attribute-2 “cotton”, attribute-3 “high” and so on. The attribute modeler 150 may then perform variable transformation like one-hot encoding for categorical variables or scale numeric variables by using log or exponential functions to obtain a second table 510.

The second table 510 may include encoded values for the different attributes of the products as illustrated in the second table 510. A third table 512 may be then created based on the first table 506 and the second table 510. The third table 512 may include a composite variable for each product. The composite variable may be created using sales and real-time data such as total positive feedback, click, and viewed etc. for different time period. The composite variable may be calculated using weighted average or simple average and may indicate attribute data related to the product in different time periods.

The composite variable for each product is then used to create the plurality of mutually exclusive batches 570. The second table 510 may be used to obtain the composite variable for each product. However, in order to capture the time impact on data, a composite variable may be generated such that it represents products from different time periods. Stratified sampling 560 may be then performed on the composites variables of different time periods to obtain the mutually exclusive batches 570.

Depending on the complexity of data, batches may be created by using stratified sampling such that each batch may represent equal distribution of data from each time-period representing a product from each categories of the product portfolio. In an example, equal size batches may be formed from large data pool that may be processed in parallel instead of processing sequentially. This method of batch processing may be cost-efficient as well as time-efficient. The attribute modeler 150 may identify optimum number of batches that need to be selected, based on various parameters such as the size of data, level of dimension captured, data distribution, processing time per batch, operation cost etc. These parameters may be used with complex optimization techniques such as linear programming, stochastic programming etc. to obtain an ideal number of batches. Final distribution of data in each batch may always represent population distribution, and may be achieved by sampling techniques including the stratified sampling technique or the synthetic minority over-sampling technique (SMOTE). Once the plurality of mutually exclusive batches 570 are created, the attribute modeler 150 may use the machine learning techniques to provide the attribute composite score.

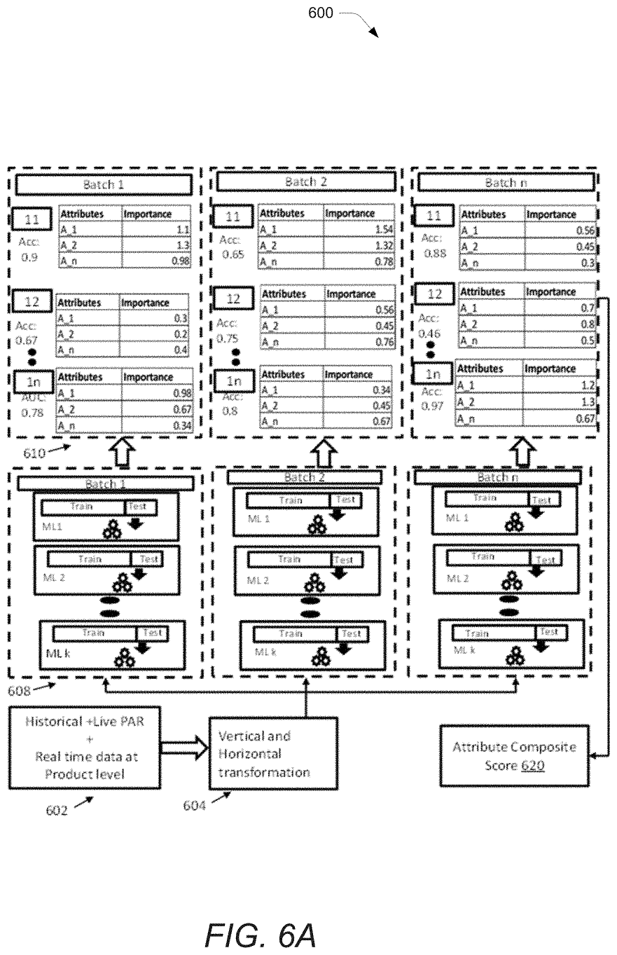

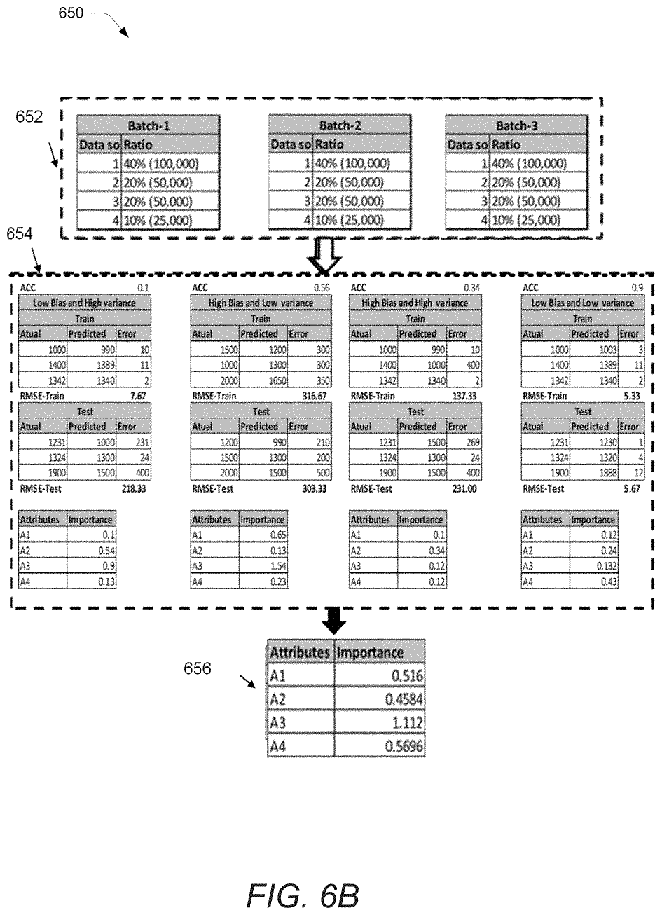

FIGS. 6A and 6B illustrate example implementations 600, 650 of the attribute modeler 150 for obtaining the attribute composite score. To obtain the attribute composite score, the attribute modeler 150 may obtain historical and live product analytical record and the real-time data 602. The historical and live product analytical data may be obtained from the historical data and the real-time data related to the product may be obtained from the clean data. The attribute modeler 150 may perform vertical and horizontal transformation 604 on the historical and live product analytical record and the real-time data 602 to obtain mutually exclusive batches 608. Various test and train methods leveraging machine learning techniques like autoregressive integrated moving average with explanatory variable model (ARIMAX), unobserved components model (UCM), extreme gradient boosting model (XgBoost) etc, may be used on the mutually exclusive batches 608 to obtain variable importance scores for the attributes in a plurality of subsets 610. Importance scores across all subsets 610 may be aggregated to create the attribute composite score 620. The attribute composite score 620 may be calculated using absolute average, weighted average with mean absolute percentage error (MAPF), mean absolute deviation (MAD), and accuracy (Acc) as weights.

In an example, the attribute composite score 620 for attribute A_1 may be calculated using the following equations, individually or in any combination thereof:

$$Absolute average : A\_ 1 = \frac{A\_ 111 + A\_ 121 + ⋯ + * A\_ 1 kn}{Total number of models ( kn )} ;$$

$$Weighted average : A\_ 1 = \frac{Acc 11 * A\_ 111 + Acc 21 * A\_ 121 + ⋯ + Acckn * Vkn}{Acc 11 ++ Acc21\_ + Acckn} ;$$

$$Weighted Average : A\_ 1 = \frac{MAPE 11 * A\_ 111 + ⋯ + MAPEkn * A\_ 1 kn}{MAPE 11 ++ MAPE 21. . + MAPEkn} ; and$$

$$Weighted Average : A\_ 1 = \frac{MAD 11 * A\_ 11 + ⋯ + MADkn * A\_ 1 kn}{MAD 11 ++ MAD 21. . + MADkn}$$

where, n refers to batch number and k refers to number of times the machine learning technique is used.

The attribute composite score 620 may also be obtained by using an ensemble technique as illustrated in example implementation 650. In order to obtain a robust solution, biasness and variance should be balanced. For instance, a model with high invariance may represent data more accurately but may lead to over-fitting to noisy data. On the other hand, a model with high bias may under-fit the data which may result into low accuracy. In order to reach an optimized score which represents a balance between the bias and the variance, the attribute composite score 620 may be calculated using inputs from multiple models 654, which also results in the robust solution that includes strengths of the multiple models 654. In the ensemble technique, each of attribute composite scores 656 may be captured by calculating a composite score which is generated based on the multiple models 654 constructed on different batches 652. The attribute modeler 150 may learn from each of the models 654 in terms of its weakness and strengths that may be captured to generate most optimized and strong solution. This may improve the accuracy and may also remove any kind of biasness in the data, if any. The attribute modeler 150 may handle large amount of information from various platforms effectively, as the batches may be processed in parallel. The attribute modeler 150 may calculate attribute composite scores 656 for each of the attributes such that each attribute composite score is represented by a majority of the population based on model accuracy. For example, if ‘n’ numbers of models are generated that provide ‘n’ number of outputs, each output may provide importance to each attribute which may then be used to calculate the attribute composite score. So, if attribute-1 is considered as the most preferred attribute by 80% of models whereas remaining 20% consider attribute-2 as the most preferred attribute, then attribute-1 will be considered as the highly preferred attribute. Therefore, weight for attribute-1 may be determined based on the following relation:

W1*Acc1+W2*Acc2+ . . . Wn*Accn

In the above relation, W1 refers to weight assigned by model-1 and Acct refers to accuracy of the model-1. Thus, the attribute composite score 656 may be based on output from all models and their high accuracy. Further, the attribute composite scores 656 for each of the attributes may indicate an attribute ranking order of the attributes. The attributes in this case may be the plurality of real-time potential attribute recommendations. A set of preferred attribute recommendations may then be provided by the attribute modeler 150 based on the real-time potential attribute recommendations ranked highest in the attribute ranking order.

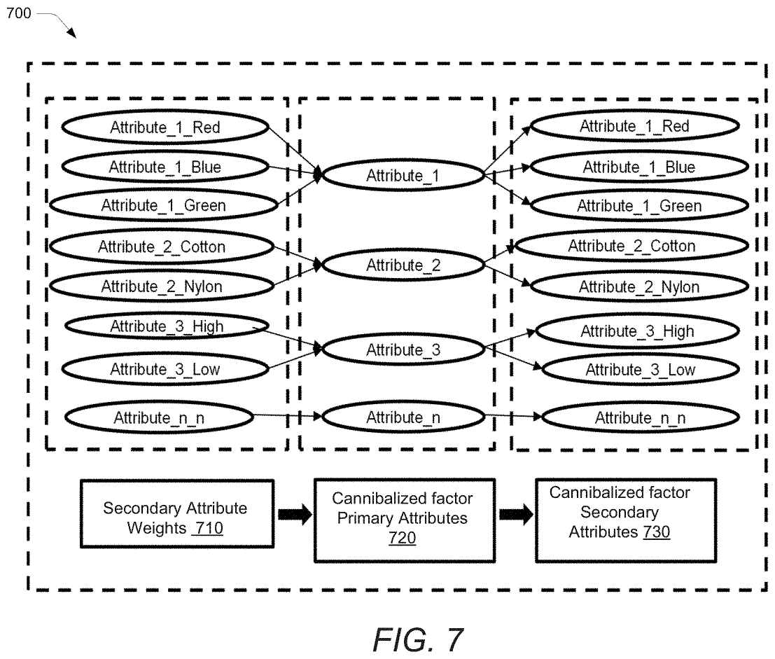

FIG. 7 illustrates an example implementation 700 of the cannibalization factor and similarity index identifier 160 for obtaining the cannibalization factor. The cannibalization factor may be provided for each of the set of preferred attribute recommendations, and may indicate impact of each of the set of preferred attribute recommendations on sale of the plurality of similar products. Cannibalization factor may be obtained by using following equations:

$${x}_{ij} = {S}_{ij} * {A}_{ij} * {W}_{ij}$$

$$Div\_Factor = {\sum }_{i = 1 , j = 1}^{m , n} ( \begin{matrix}m \\ i\end{matrix} ) {S}_{i} * {A}_{ij} * {W}_{j}$$

$$Cann\_Fact = {\sum }_{i = 1 , j = 1}^{m , n} ( \begin{matrix}m \\ i\end{matrix} ) {( \frac{{X}_{ij}}{{Div}_{{Factor}_{j}}} )}^{p}$$

In the above relations, m refers to total number of products in a portfolio, n refers to total number of secondary attributes, i refers to the exact product from amongst the m products, j refers to the exact attribute from the n attributes, x refers to sales contribution with respect to product attributes (for example, contribution of attribute-1 of product-1 towards the total sales of product-1), Div_Factor refers to sum of all the sales contribution from n attributes across m products, S refers to the composite variable, A refers to the primary attributes, W refers to weights of the secondary attributes Cann_Fact refers to the cannibalization factor, and p refers to power of cannibalization which may vary between 2 to 3.

In an example, secondary attributes weights 710 may be provided to cannibalized factor primary attributes 720 to obtain cannibalized factor secondary attributes 730. In an example, the cannibalization factor and similarity index identifier 160 may use complex statistical equations to calculate cannibalization factor for the primary attributes and the secondary attributes.

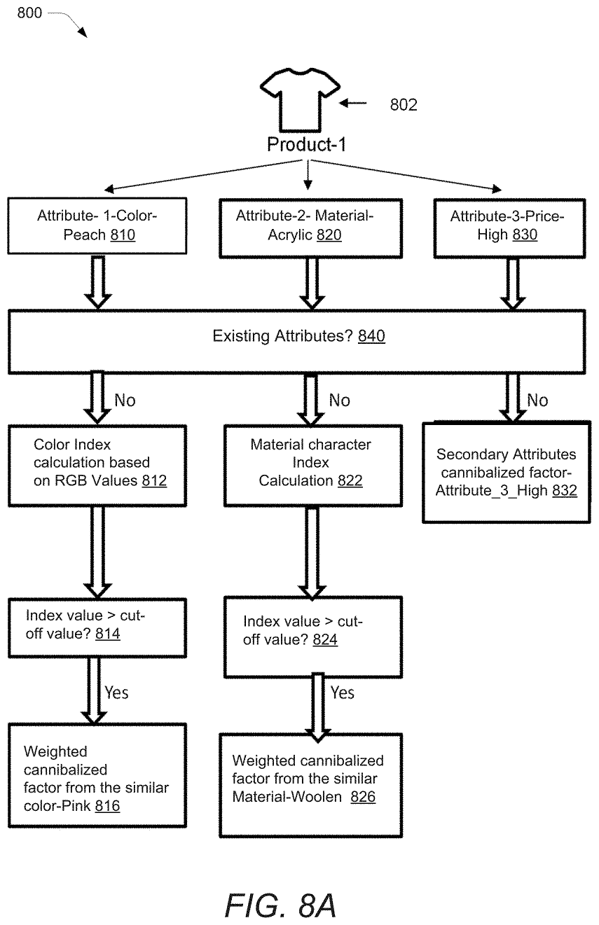

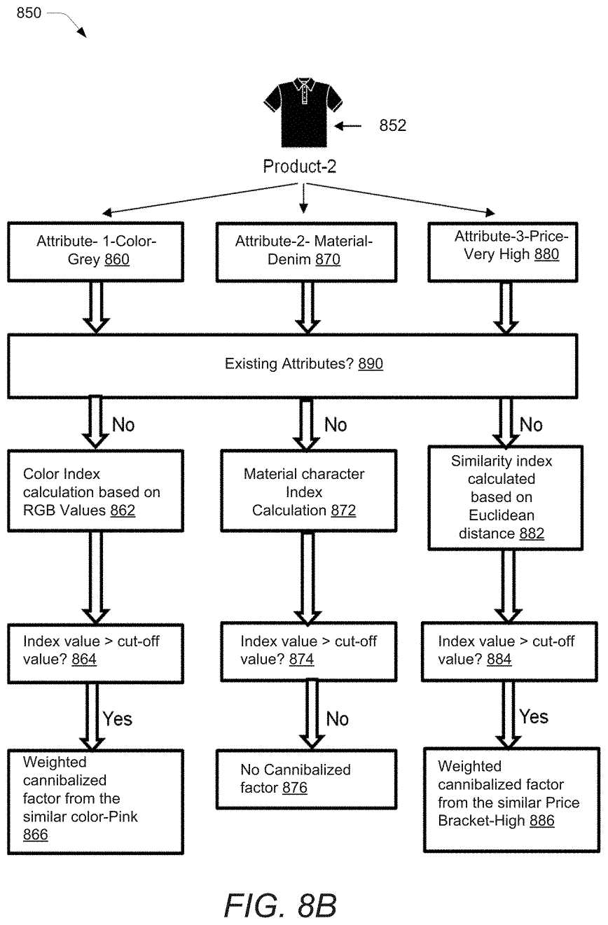

FIGS. 8A and 8B illustrate example implementations 800, 850 of the cannibalization factor and similarity index identifier 160 for obtaining the similarity index. The cannibalization factor and similarity index identifier 160 may provide the similarity index for each of set of preferred attribute recommendations. The similarity index may indicate similarity between each of the set of preferred attribute recommendations and a set of existing attributes associated to the plurality of similar products. The example implementation 800 illustrates steps involved in obtaining the similarity index for each of the set of preferred attribute recommendations for product-1 802, when each of the set of preferred attribute recommendations includes partially new attributes. The cannibalization factor and similarity index identifier 160 may compare attributes 810, 820, 830 associated with the product-1 802 with existing attributes 840.

For example, Attribute-1-Color-Peach 810, Attribute-2-Material-Acrylic 820, and Attribute-3-Price-High 830 may be compared with the existing attributes 840. If the Attribute-1-Color-Peach 810 does not match any of the existing attributes 840, a color index calculation may be performed based on RGB values at step 812 to obtain an index value, i.e., a similarity index. In an example, complex RGB index may be calculated to calculate the similarity between colors of the attributes. At step 814, the index value may be compared with a cut-off value. If the index value is greater than the cut-off value a weighted cannibalized factor from a similar color-Pink may be calculated at step 316. Similarly, if the Attribute-2-Material-Acrylic 820 does not match any of the existing attributes 840, a material character index calculation may be performed at step 822 to obtain an index value, i.e., a similarity index. At step 824, the index value may be compared with a cut-off value, and if the index value is greater than the cut-off value a weighted cannibalized factor from a similar material-Woolen may be calculated at step 826. Further, if the Attribute-3-Price-High 830 does not match any of the existing attributes 840, a secondary attributes cannibalized factor ‘Attribute_3_High’ is obtained at step 832.

The example implementation 850 illustrates steps involved in obtaining the similarity index for each of the set of preferred attribute recommendations for product-2 852, when each of the set of preferred attribute recommendations includes entirely new attributes. The cannibalization factor and similarity index identifier 160 may compare attributes 860, 870, 880 associated with the product-2 852 with existing attributes 890.

For example, Attribute-1-Color-Grey 860, Attribute-2-Material-Denim 870, and Attribute-3-Price-Very High 880 may be compared with the existing attributes 890. If the Attribute-1-Color-Grey 860 does not match any of the existing attributes 890, a color index calculation may be performed based on RGB values at step 862 to obtain an index value, i.e., a similarity index. At step 864, the index value may be compared with a cut-off value. If the index value is greater than the cut-off value a weighted cannibalized factor from a similar color-Pink may be calculated at step 866. Similarly, if the Attribute-2-Material-Denim 870 does not match any of the existing attributes 890, material character index calculation may be performed at step 872 to obtain an index value, i.e., a similarity index. At step 874, the index value may be compared with a cut-off value, and if the index value is less than the cut-off value cannibalization factor may not be calculated 876. Further, if the Attribute-3-Price-Very High 880 does not match any of the existing attributes 890, a similarity index may be calculated based on Euclidean distance at step 882. At step 884, the similarity index value may be compared with a cut-off value, and if the similarity index value is greater than the cut-off value a weighted cannibalized factor from a similar price bracket-High may be calculated at step 886.

Thus, the cannibalization factor and similarity index identifier 160 may not only use descriptive rules like category and sub-category to find similar products from an existing product portfolio, but may also generate complex similarity index to identify commonality between the products. In an example, attribute importance may be used to calculate the similarity index. Material similarity may be calculated using statistics methods like Euclidean distance to identify most similar material with similar characteristics. In an example, the cannibalization factor and similarity index identifier 160 may use artificial intelligence based machine learning predictive techniques to obtain the cannibalization factor and the similarity index. A final cannibalization factor may be calculated for products with no, partial or entirely new attributes.

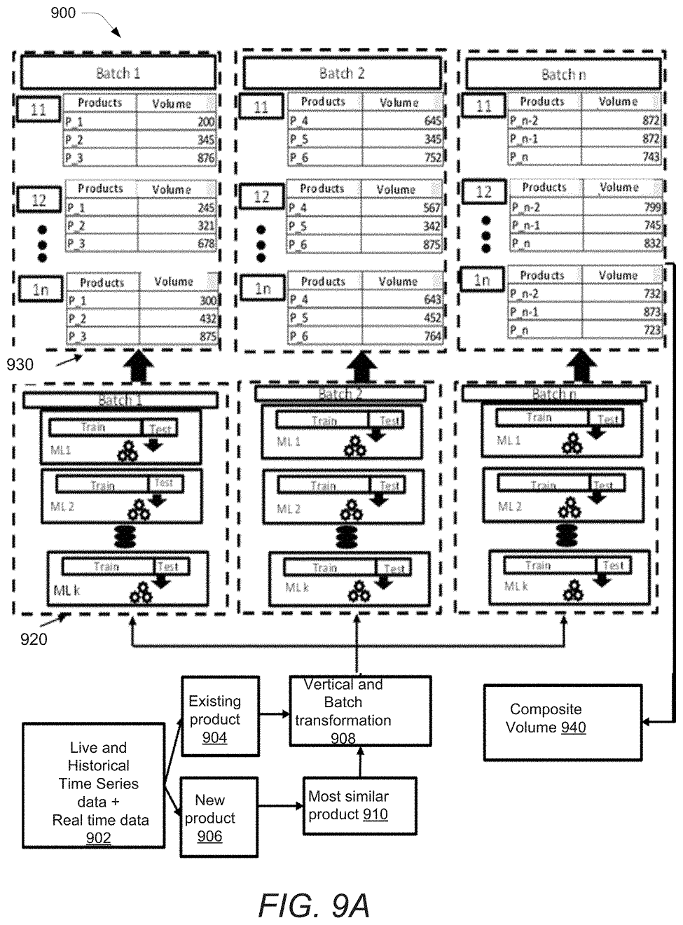

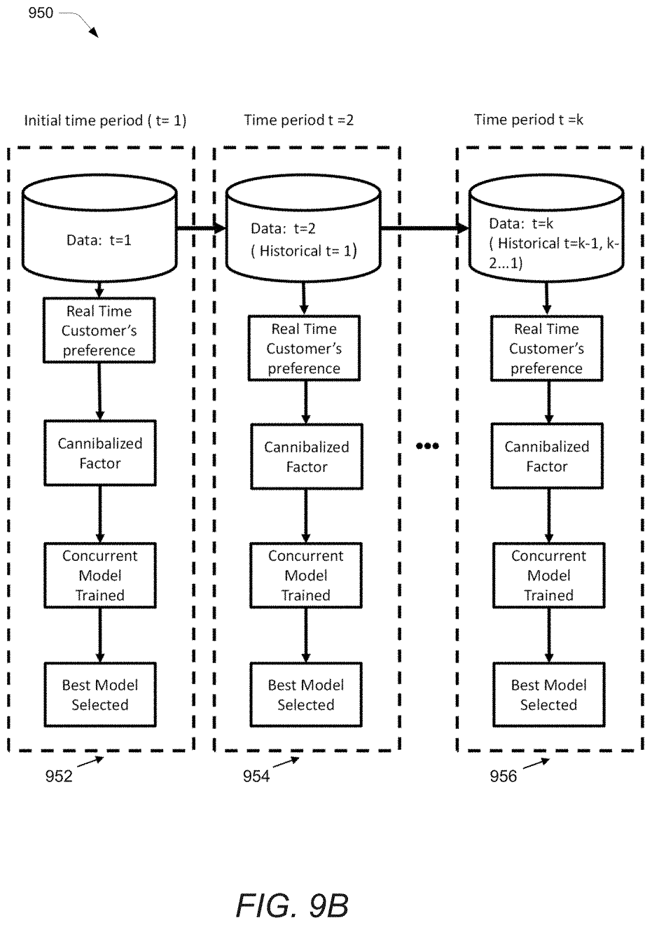

FIG. 9A illustrates an example implementation 900 of the capacity forecasting planner 170 for obtaining real-time demand forecast. The capacity forecasting planner 170 may obtain live and historical time series data and real-time data 902 related to plurality of products from the clean data. If the obtained data is related to a new product 906, the capacity-forecasting planner 170 may obtain a similarity index for the new product 906 and identify a most similar product 910 based on the similarity index. The capacity forecasting planner 170 may then perform vertical and batch transformation 908 on the live and historical time series data and real-time data 902 to obtain mutually exclusive batches 920. If the obtained data is related to an existing product 904, the capacity forecasting planner 170 may perform vertical and batch transformation 908 on the live and historical time series data and real-time data 902 to obtain the mutually exclusive batches 920.

Various machine learning techniques including train/test method may be performed on the mutually exclusive batches 920 to obtain product volumes in a plurality of subsets 930. Product volumes associated to a product, across all subsets 930, may be then aggregated to create a composite volume 940 for the product. The composite volume may be indicative of the demand forecast of the product. The capacity forecasting planner 170 may thus create an ensemble model using the real-time and historical time series data to provide the composite volume for each of the plurality of similar products, indicating the real-time demand forecast of the product. In an example, the obtained data may be divided onto mutually exclusive batches to avoid high operational inefficiencies and high cost. The ensemble model may run simultaneously on selected time series data and real time variables.

In an example, machine learning techniques like linear regression, autoregressive integrated moving average with explanatory variable (ARIMAX), unobserved components model (UCM) or deep learning techniques like long short term memory (LSTM) may be used to predict total volume for each product in the product portfolio. Further, the composite final volume for the product may be created using absolute average, weighted average with mean absolute percentage error (MAPF), mean absolute deviation (MAD), and Accuracy as weights.

FIG. 9B illustrates an example implementation 950 of self-learning modeling technique used by the capacity forecasting planner 170. As illustrated in the FIG. 9B. at an initial time period (1=1), steps 952 to obtain a best model that predicts demand forecast may include obtaining data at t=1 from the data pre-processor 104, obtaining real-time customer preferences and cannibalization factor, training a concurrent model and selecting a best model based on the concurrent model. Similar steps are repeated at 954 wherein real-time data may be obtained at t=2 and historical data may be obtained at t=1 to identify real-Lime customer preferences. Similarly, at t=k, real-Lime data may be obtained at t=k and historical data may be obtained at t=k−1, k−2, . . . 2,1 to identify real-time customer preferences and to eventually obtain a best model at t=k. This method of self-training, in every new iteration may update primary and secondary attribute recommendations. As soon as the clean data is obtained by the system 110, the system 110 may trigger process of data source retraining. This enables the system 110 to provide enriched data containing optimized attribute recommendations.

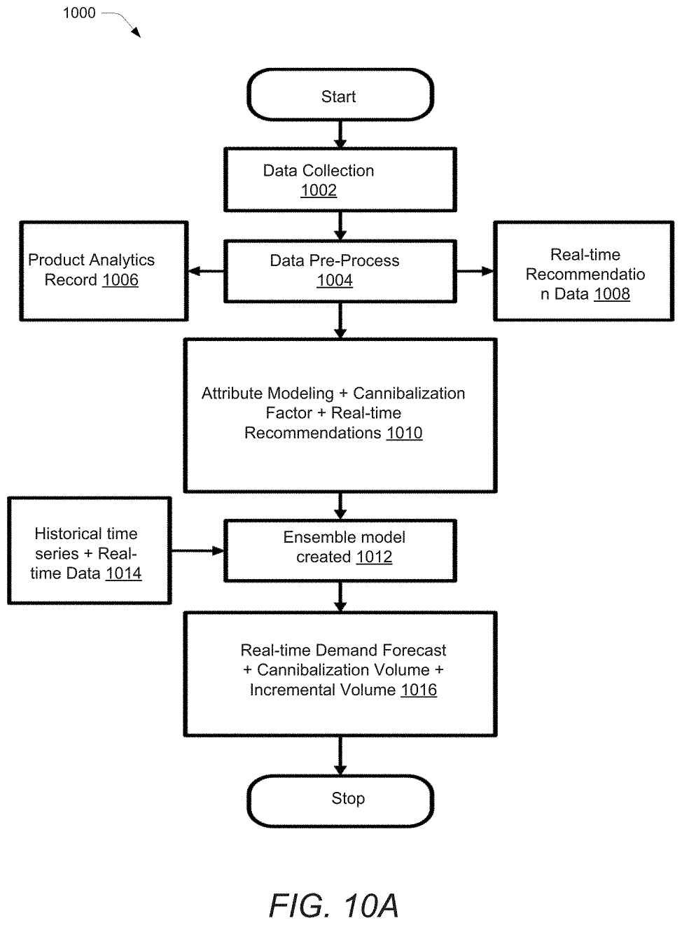

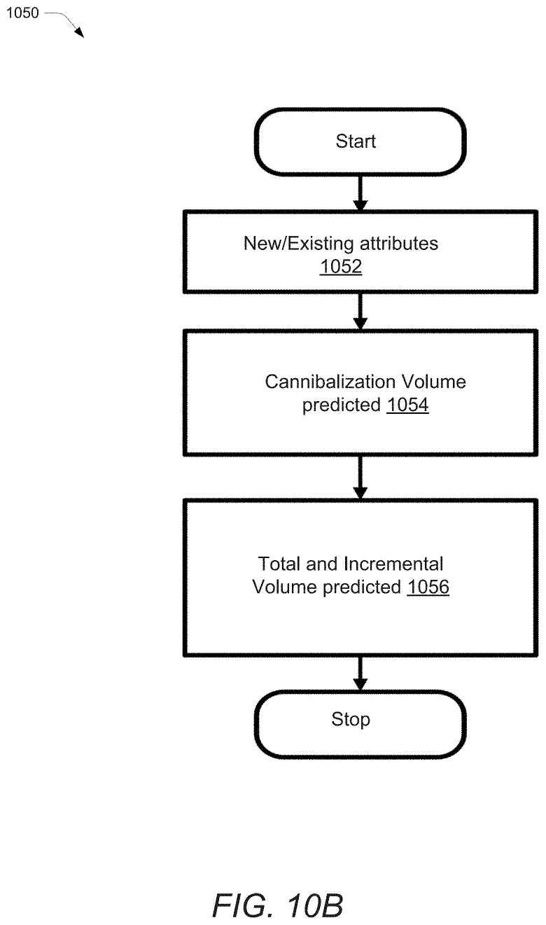

FIG. 10A illustrates process flowchart 1000 of the capacity forecasting planner 170 to obtain the real-time demand forecast of the product. At block 1002, data may be collected and, at block 1004, the data may be pre-processed. In an example, the data may be collected from the plurality of data sources 102 and the data may be pre-processed by the data pre-processor 104 to obtain pre-processed data. The pre-processed data may be stored as a product analytics record 1006 and real-time recommendation data 1008 may be obtained from the pre-processed data. In an example, the product analytics record 1006 may be historical data associated to the product and may be stored in the data pre-processor 104. In an example, the real-time recommendation data 1008 may include the set of potential attribute recommendations. The pre-processed data may then be used to obtain attribute modeling, cannibalization faction and real-time recommendations 1010. In an example, the real time recommendations include the set of preferred attribute recommendations. An ensemble model may be then created based on historical time series data and real-time data 1014, and the attribute modeling, cannibalization faction and real-time recommendations 1010. The created ensemble model may then be used by the capacity-forecasting planner 170 to obtain the real-time demand forecast, the cannibalization volume and the incremental volume 1016. The cannibalization volume

FIG. 10B illustrates process flowchart 1050 of the model predictor 180 to provide the predicted cannibalization volume and the predicted incremental volume. The model predictor 180 may provide the predicted cannibalization volume in real-time for the product based on the cannibalization factor. The predicted cannibalization volume may predict impact of sale of the product having the set of preferred attribute recommendations, on the sale of the plurality of similar products. The model predictor 180 may also provide, in real-time, the predicted incremental volume for the product based on the predicted cannibalization volume and the composite volume. The predicted incremental volume may predict future sale volume of the product having the set of preferred attribute recommendations.

The model predictor 180 may receive recommendations related to new or existing attributes 1052 related to the product, and may predict the cannibalization volume 1054 and total and incremental volume 1056 based on the received recommendations. In an example, the model predictor 180 use real data to identify customer's changing preferences and feedback. An attribute model build may then take place and attribute's importance and cannibalization may be update and calculated. In an example, the model may be scored at a fixed frequency like daily, weekly, bi-monthly, monthly. A concurrent forecast model may be then obtained by the model predictor 180 to predict total volume. The total volume may indicate volume of products that may be required in future. The model predictor 180 may then calculate the product's incremental and cannibalized volume based on the set of preferred attribute recommendations.

The insights generator 190 may then determine the set of final attribute recommendations from the set of preferred attribute recommendations based the cannibalization volume, the similarity index, the real-time demand forecast, the predicted cannibalization volume, and the predicted incremental volume. In an example, the insights generator 190 may provide real-time scoring of the attributes, in batches, at a fixed frequency, for example daily, weekly. Rescoring results may then be stored in a centralized server (not shown) on real-time basis.

The insights generator 190 may provide the results, i.e., the set of final attribute recommendations to local servers on a set frequency. The insights generator 190 may provide an optimized design for the product based on the set of final attribute recommendations. In an example, the insights generator 190 may provide product level demand, incremental and cannibalized forecast for the final attributes, optimized set of attribute with minimum cannibalization impact and high incremental volume, data related to customer's changing behavior, trend and sentiments, most talked about products and attributes, highly searched, viewed, clicked products and the list of possible new attributes that may be introduced for the product.

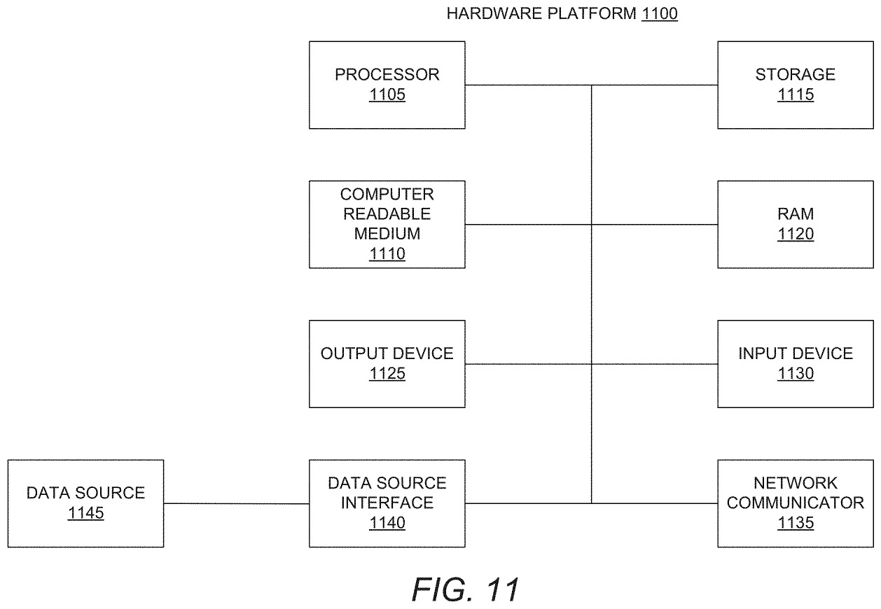

FIG. 11 illustrates a hardware platform 1100 for the implementation of the system for providing real-time optimized product design. The hardware platform 1100 may be a computer system 1100 that may be used with the examples described herein. The computer system 1100 may represent a computational platform that includes components that may be in a server or another computer system. The computer system 1100 may execute, by a processor (e.g., a single or multiple processors) or other hardware processing circuit, the methods, functions and other processes described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system 1100 may include a processor 1105 that executes software instructions or code stored on a non-transitory computer-readable storage medium 1110 to perform methods of the present disclosure. The software code includes, for example, instructions to gather pre-processed data and analyze the pre-processed data. In an example, the product design optimizer 130 may use the software codes.

The instructions on the computer-readable storage medium 1110 are read and stored the instructions in storage 1115 or in random access memory (RAM) 1120. The storage 1115 provides a large space for keeping static data where at least some instructions could be stored for later execution. The stored instructions may be further compiled to generate other representations of the instructions and dynamically stored in the RAM 1120. The processor 1105 reads instructions from the RAM 1120 and performs actions as instructed.

The computer system 1100 further includes an output device 1125 to provide some of the results of the execution as output including, but not limited to, visual information to users, such as external agents or customers. The output device 1125 can include a display on computing devices and virtual reality glasses. For example, the display can be a mobile phone screen or a laptop screen. GUIs and/or text are presented as an output on the display screen. The computer system 1100 further includes an input device 1130 to provide a user or another device with mechanisms for entering data and/or otherwise interact with the computer system 1100. The input device 1130 may include, for example, a keyboard, a keypad, a mouse, or a touchscreen. Each of these output devices 1125 and input devices 1130 could be joined by additional peripherals. In an example, the output device 1125 may be used to display a design recommendation for a product.

A network communicator 1135 may be provided to connect the computer system 1100 to a network and in turn to other devices connected to the network including other clients, servers, data stores, and interfaces, for instance. A network communicator 1135 may include, for example, a network adapter such as a LAN adapter or a wireless adapter. The computer system 1100 includes a data source interface 1140 to access data source 1145. A data source is an information resource. As an example, a database of exceptions and rules may be a data source. Moreover, knowledge repositories and curated data may be other examples of data sources.

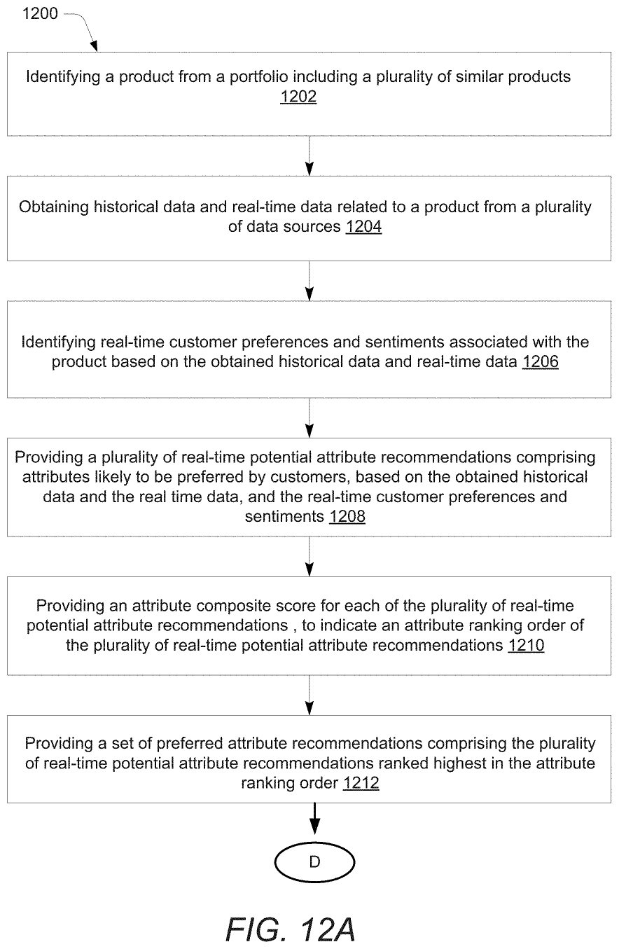

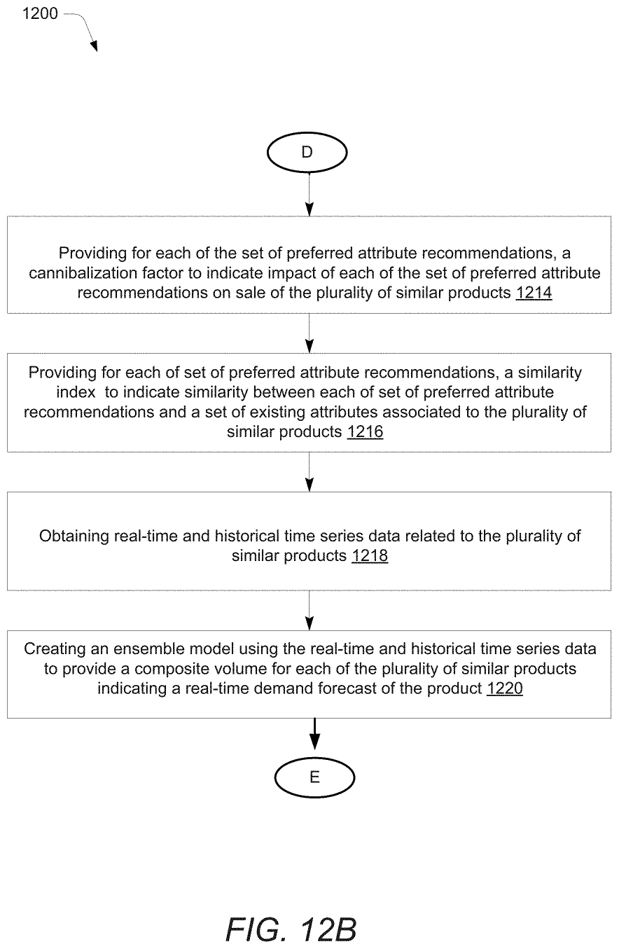

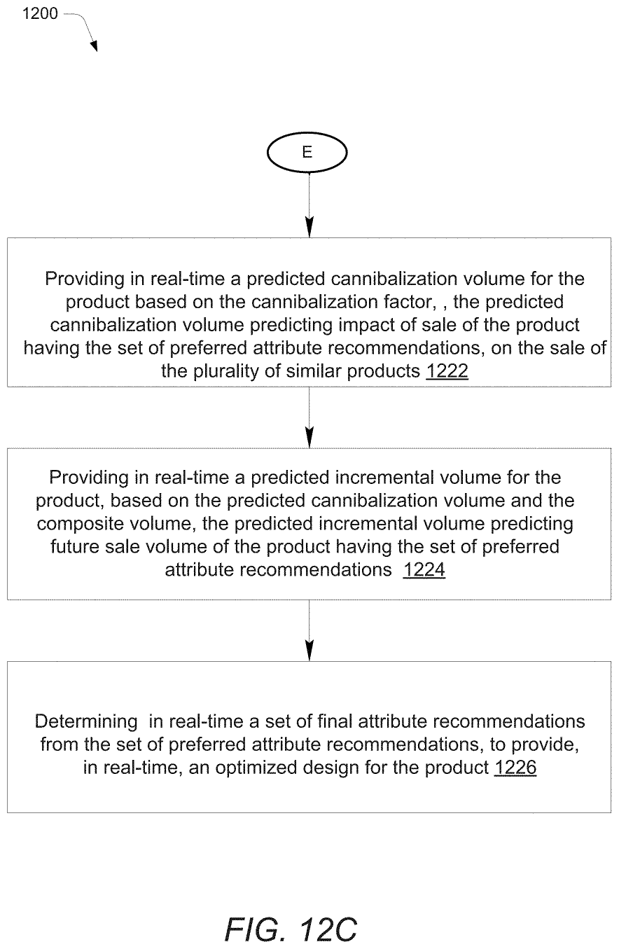

FIGS. 12A, 12B and 12C illustrate a process flowchart for providing real-time optimized product design, according to an example embodiment of the present disclosure.

It should be understood that method steps are shown here for reference only and other combinations of the steps may be possible. Further, method 1200 may contain some steps in addition to the steps shown in FIGS. 12A, 12B and 120. For the sake of brevity, construction and operational features of the system 110 which are explained in detail in the description of FIGS. 1-11 are not explained in detail in the description of FIGS. 12A, 12B and 120. The method 1200 may be performed by a component of the system 110, such as the processor 120, the product design optimizer 130, the attribute analyzer 140, the attribute modeler 150, the cannibalization factor and similarity index identifier 160, the capacity forecasting planner 170, the model predictor 180, and the insights generator 190.

At block 1202, a product from a portfolio including a plurality of similar products may be identified. In an example, the attribute analyzer 140 may identify the product from the portfolio.

At block 1204, historical data and real-time data related to a product from a plurality of data sources may be obtained. The historical data and the real-time data may include data related to a plurality of attributes of the product including a plurality of primary attributes and each of the plurality of primary attributes including a plurality of secondary attributes. In an example, the attribute analyzer 140 may obtain the historical data and real-time data.

At 1206, real-time customer preferences and sentiments associated with the product based on the obtained historical data and real-time data may be identified. In an example, the attribute analyzer 140 may identify the real-time customer preferences and sentiments.

At 1208, a plurality of real-time potential attribute recommendations comprising attributes likely to be preferred by customers may be provided, based on the obtained historical data and the real time data, and the real-time customer preferences and sentiments. In an example, the attribute analyzer 140 may provide the plurality of real-time potential attribute recommendations. To provide the plurality of real-time potential attribute recommendations, the method 1200 may further include obtaining the historical data and the real-time data related to the product from the plurality of data sources, pre-processing the historical data and the real-time data to obtain clean data, analyzing the clean data to identify the real-time customer preferences and sentiments associated with the product, the plurality of primary attributes and the plurality of secondary attributes, identifying in real-time based on the analysis, a set of potential attributes of the product, the set of potential attributes including preferred primary attributes and preferred secondary attributes, and mapping the set of potential attributes with the clean data to provide a plurality of real-time potential attribute recommendations.

At 1210, an attribute composite score for each of the plurality of real-time potential attribute recommendations may be provided. In an example, the attribute modeler 150 may provide the attribute composite score.

At 1212, a set of preferred attribute recommendations may be provided comprising the plurality of real-time potential attribute recommendations ranked highest in the attribute ranking order. In an example, the attribute modeler 150 may provide the set of preferred attribute recommendations. To provide the set of preferred attribute recommendations, the method 1200 may include obtaining a historical analytical record of the product from the historical data, providing a composite variable for the product based on the historical analytical record and the plurality of real-time potential attribute recommendations, the composite variable indicating attribute data related to the product in different time periods, and creating a plurality of mutually exclusive attribute batches based on the composite variable, and apply a plurality of machine learning techniques to provide the attribute composite score and the set of preferred attribute recommendations.

At 1214, a cannibalization factor may be provided for each of the set of preferred attribute recommendations to indicate impact of each of the set of preferred attribute recommendations on sale of the plurality of similar products. In an example, the cannibalization factor and similarity index identifier 160 may provide the cannibalization factor.

At 1216, a similarity index may be provided for each of set of preferred attribute recommendations to indicate similarity between each of set of preferred attribute recommendations and a set of existing attributes associated to the plurality of similar products. In an example, the cannibalization factor and similarity index identifier 160 may provide the similarity index.

At 1218, real-time and historical time series data related to the plurality of similar products may be obtained. In an example, the capacity forecasting planner 170 may obtain the real-time and historical time series data.

At 1220, an ensemble model may be created using the real-time and historical time series data to provide a composite volume for each of the plurality of similar products, indicating a real-time demand forecast of the product based. In an example, the capacity-forecasting planner 170 may create the ensemble model.

At 1222, a predicted cannibalization volume for the product may be provided in real-time based on the cannibalization factor. The predicted cannibalization volume may predict impact of sale of the product having the set of preferred attribute recommendations, on the sale of the plurality of similar products. In an example, the model predictor 180 may provide the predicted cannibalization volume.

At 1224, a predicted incremental volume for the product may be provided in real-time, based on the predicted cannibalization volume and the composite volume. The predicted incremental volume may predict future sale volume of the product having the set of preferred attribute recommendations. In an example, the model predictor 180 may provide the predicted incremental volume.

At 1226, a set of final attribute recommendations for the product may be determined in real-time, from the set of preferred attribute recommendations, to provide, in real-time, an optimized design for the product. In an example, the insights generator 190 may determine the set of final attribute recommendations and provide the optimized design for the product.

To obtain the clean data, the method 1200 may include extracting user feedback from the real-time data, performing text analytics on the user feedback sentences to obtain segmented words, performing word correction on the segmented words and tag different part of speech from the segmented words using text tokenization to obtain tokenized data, and removing stop words from the tokenized data to obtain clean data.

In an example, to obtain clean data, the method 1200 may include extracting at least one of clickstream data, and web search data from the real-time data to obtain extracted data, generating key performance indicators from the extracted data based on deep learning techniques, and performing click stream analytics based on the key performance indicators to obtain clean data.

In an example, the plurality of data sources may provide data from at least one of social media platforms, search engines, websites, applications, geo location services, and transaction and product data repositories.

The method 1200 may further include determining the set of final attribute recommendations from the set of preferred attribute recommendations based on a set of pre-determined rules, the cannibalization volume, the similarity index, the real-time demand forecast, the predicted cannibalization volume, and the predicted incremental volume.

In an example, the method 1200 may be a computer-implemented method. In an example, the method 1200 may be practiced using a non-transitory computer-readable medium including machine readable instructions that are executable by a processor to perform the method 1200 or to implement the functionality of the system 110.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the present disclosure, which is intended to be defined by the following claims and their equivalents in which all terms are meant in their broadest reasonable sense unless otherwise indicated.

I/We claim:

1. A system comprising:
a processor; and
a product design optimizer coupled to the processor to recommend, in real-time, a design for a product, wherein the product is a part of a product portfolio having a plurality of similar products, the product design optimizer comprising:
an attribute analyzer to:
obtain historical data and real-time data related to the product from a plurality of data sources, the historical data and the real-time data including data related to a plurality of attributes of the product including a plurality of primary attributes, each of the plurality of primary attributes including a plurality of secondary attributes;
identify real-time customer preferences and sentiments associated with the product based on the obtained historical data and real-time data; and,
determine a plurality of real-time potential attribute recommendations comprising attributes likely to be preferred by customers, based on the obtained historical data and the real time data, and the real-time customer preferences and sentiments;
an attribute modeler to:
ascertain an attribute composite score for each of the plurality of real-time potential attribute recommendations, to indicate an attribute ranking order of the plurality of real-time potential attribute recommendations; and
identify a set of preferred attribute recommendations comprising selected real-time potential attribute recommendations from amongst the plurality of real-time potential attribute recommendations selected based on the attribute ranking order;
a cannibalization factor and similarity index identifier to:
determine for each of the set of preferred attribute recommendations, a cannibalization factor to indicate impact of each of the set of preferred attribute recommendations on sale of the plurality of similar products in the product portfolio; and
determine for each of set of preferred attribute recommendations, a similarity index to indicate similarity between each of set of preferred attribute recommendations and a set of existing attributes associated with the plurality of similar products;
a model predictor to:
predict, in real-time, a cannibalization volume for the product based on the cannibalization factor, the cannibalization volume indicative of impact of sale of the product on the sale of the plurality of similar products; and
predict, in real-time, an incremental volume for the product, based on the cannibalization volume and the composite volume, the incremental volume being indicative of future sale volume of the product;
an insights generator to determine, in real-time, a set of final attribute recommendations for the product, from the set of preferred attribute recommendations, to attain, in real-time, an optimized design for the product.

2. The system of claim 1, wherein, to obtain the plurality of real-time potential attribute recommendations, the attribute analyzer is to:
pre-process the historical data and the real-time data to obtain dean data, wherein the real-time customer preferences and sentiments associated with the product are identified based on the clean data;
identify, in real-time, a set of potential attributes of the product, the set of potential attributes including preferred primary attributes and preferred secondary attributes; and
map the set of potential attributes with the clean data to provide the plurality of real-time potential attribute recommendations.

3. The system of claim 1, wherein to provide the set of preferred attribute recommendations, the attribute modeler is to:
obtain a historical analytical record of the product from the historical data;
provide a composite variable for the product based on the historical analytical record and the plurality of real-time potential attribute recommendations, the composite variable indicating attribute data related to the product in different time periods;
create a plurality of mutually exclusive attribute batches based on the composite variable, and apply a plurality of machine learning techniques to ascertain the attribute composite score.

4. The system of claim 2, wherein to obtain the dean data, the attribute analyzer is to:
extract user feedback from the real-time data, the user feedback comprising sentences of user feedback;
perform text analytics on the sentences to obtain segmented words;
obtain tokenized data by tagging different parts of speech from the segmented words using text tokenization, wherein word correction is performed on the segmented words for obtaining the tokenized data; and
remove stop words from the tokenized data to obtain the dean data.

5. The system of claim 2, wherein to obtain the dean data, the attribute analyzer is to:
extract clickstream data, web search data, or a combination thereof from the real-time data to obtain extracted data;
generate key performance indicators from the extracted data based on deep learning techniques; and
perform click stream analytics based on the key performance indicators to obtain the clean data.

6. The system of claim 1, further comprising a capacity forecasting planner to:
obtain real-time and historical time series data related to the plurality of similar products;
create an ensemble model using the real-time and historical time series data to provide a composite volume for each of the plurality of similar products to ascertain a real-time demand forecast of the product, the real-demand being indicative of the sale of the product and impact on the cannibalization volume.

7. The system of claim 6, wherein the insights generator is to determine the set of final attribute recommendations from the set of preferred attribute recommendations based on a set of pre-determined rules, the cannibalization volume, the similarity index, the real-time demand forecast, and the incremental volume.

8. A method comprising:
obtaining, by a processor, historical data and real-time data related to a product from a plurality of data sources, the product being a part of a product portfolio having a plurality of similar products the historical data and the real-time data including data related to a plurality of attributes of the product including a plurality of primary attributes and each of the plurality of primary attributes including a plurality of secondary attributes;
identifying, by the processor, real-time customer preferences and sentiments associated with the product based on the obtained historical data and real-time data;
determining, by the processor, a plurality of real-time potential attribute recommendations comprising attributes likely to be preferred by customers, based on the obtained historical data and the real time data, and the real-time customer preferences and sentiments;
ascertaining, by the processor, an attribute composite score for each of the plurality of real-time potential attribute recommendations, to indicate an attribute ranking order of the plurality of real-time potential attribute recommendations;
identifying, by the processor, a set of preferred attribute recommendations selected real-time potential attribute recommendations from amongst the plurality of real-time potential attribute recommendations selected based on the attribute ranking order;
determining, by the processor, for each of the set of preferred attribute recommendations, a cannibalization factor to indicate impact of each of the set of preferred attribute recommendations on sale of the plurality of similar products in the product portfolio;
determining, by the processor, for each of set of preferred attribute recommendations, a similarity index to indicate similarity between each of set of preferred attribute recommendations and a set of existing attributes associated to the plurality of similar products;
predicting, by the processor, in real-time, a cannibalization volume for the product based on the cannibalization factor, the cannibalization volume predicting impact of sale of the product having the set of preferred attribute recommendations, on the sale of the plurality of similar products;
predicting, by the processor, in real-time, an incremental volume for the product, based on the cannibalization volume and the composite volume, the predicted incremental volume being indicative of future sale volume of the product;
determining, by the processor, in real-time, a set of final attribute recommendations for the product from the set of preferred attribute recommendations, to attain, in real-time, an optimized design for the product.

9. The method of claim 8, wherein providing the plurality of real-time potential attribute recommendations comprises:
pre-processing, by the processor, the historical data and the real-time data to obtain clean data, wherein the real-time customer preferences and sentiments associated with the product are identified based on the clean data;
identifying, by the processor, in real-time, a set of potential attributes of the product, the set of potential attributes including preferred primary attributes and preferred secondary attributes; and
mapping, by the processor, the set of potential attributes with the clean data to provide the plurality of real-time potential attribute recommendations.

10. The method of claim 8, wherein providing the set of preferred attribute recommendations includes:
obtaining, by the processor, a historical analytical record of the product from the historical data;
providing, by the processor, a composite variable for the product based on the historical analytical record and the plurality of real-time potential attribute recommendations, the composite variable indicating attribute data related to the product in different time periods; and
creating, by the processor, a plurality of mutually exclusive attribute batches based on the composite variable, and apply a plurality of machine learning techniques to ascertain the attribute composite score and the set of preferred attribute recommendations.

11. The method of claim 9, wherein obtaining the dean data includes:
extracting, by the processor, user feedback from the real-time data, the user feedback comprising sentences of user feedback;
performing, by the processor, text analytics on the sentences to obtain segmented words;
obtaining tokenized data by tagging different parts of speech from the segmented words using text tokenization, wherein word correction is performed on the segmented words as part for obtaining the tokenized data; and
removing, by the processor, stop words from the tokenized data to obtain the dean data.

12. The method of claim 9, wherein obtaining the clean data includes:
extracting, by the processor, clickstream data, web search data, or a combination thereof from the real-time data to obtain extracted data;
generating, by the processor, key performance indicators from the extracted data based on deep learning techniques; and
performing, by the processor, click stream analytics based on the key performance indicators to obtain the clean data.

13. The method of claim 8, further comprising:
obtaining real-time and historical time series data related to the plurality of similar products;
creating an ensemble model using the real-time and historical time series data to provide a composite volume for each of the plurality of similar products to ascertain a real-time demand forecast of the product, the real-demand being indicative of the sale of the product and impact on the cannibalization volume.

14. The method of claim 13, further comprising determining, by the processor, the set of final attribute recommendations from the set of preferred attribute recommendations based on a set of pre-determined rules, the cannibalization volume, the similarity index, the real-time demand forecast, and the incremental volume.

15. A non-transitory computer readable medium including machine readable instructions that are executable by a processor to:
obtain historical data and real-time data related to a product from a plurality of data sources, the product being a part of a product portfolio having a plurality of similar products the historical data and the real-time data including data related to a plurality of attributes of the product including a plurality of primary attributes and each of the plurality of primary attributes including a plurality of secondary attributes;
identify real-time customer preferences and sentiments associated with the product based on the obtained historical data and real-time data;
determine a plurality of real-time potential attribute recommendations comprising attributes likely to be preferred by customers, based on the obtained historical data and the real time data, and the real-time customer preferences and sentiments;
ascertain an attribute composite score for each of the plurality of real-time potential attribute recommendations, to indicate an attribute ranking order of the plurality of real-time potential attribute recommendations;
identify a set of preferred attribute recommendations selected real-time potential attribute recommendations from amongst the plurality of real-time potential attribute recommendations selected based on the attribute ranking order;
determine for each of the set of preferred attribute recommendations, a cannibalization factor to indicate impact of each of the set of preferred attribute recommendations on sale of the plurality of similar products in the product portfolio;
determine for each of set of preferred attribute recommendations, a similarity index to indicate similarity between each of set of preferred attribute recommendations and a set of existing attributes associated to the plurality of similar products;
predict, in real-time, a cannibalization volume for the product based on the cannibalization factor, the cannibalization volume predicting impact of sale of the product having the set of preferred attribute recommendations, on the sale of the plurality of similar products;
predict, in real-time, an incremental volume for the product, based on the cannibalization volume and the composite volume, the predicted incremental volume being indicative of future sale volume of the product;
determine, in real-time, a set of final attribute recommendations for the product from the set of preferred attribute recommendations, to attain, in real-time, an optimized design for the product.

16. The non-transitory computer-readable medium of claim 15, wherein to obtain the plurality of real-time potential attribute recommendations, the processor is to:
pre-process the historical data and the real-time data to obtain dean data, wherein the real-time customer preferences and sentiments associated with the product are identified based on the dean data;
identify, in real-time, a set of potential attributes of the product, the set of potential attributes including preferred primary attributes and preferred secondary attributes; and
map the set of potential attributes with the dean data to provide the plurality of real-time potential attribute recommendations.

17. The non-transitory computer-readable medium of claim 15, wherein to provide the set of preferred attribute recommendations, the processor is to:
obtain a historical analytical record of the product from the historical data;
provide a composite variable for the product based on the historical analytical record and the plurality of real-time potential attribute recommendations, the composite variable indicating attribute data related to the product in different time periods; and
create a plurality of mutually exclusive attribute batches based on the composite variable, and apply a plurality of machine learning techniques to ascertain the attribute composite score and the set of preferred attribute recommendations.

18. The non-transitory computer-readable medium of claim 16, wherein to obtain the dean data, the processor is to:
extract user feedback from the real-time data, the user feedback comprising sentences of user feedback;
perform text analytics on the sentences to obtain segmented words;
obtain tokenized data by tagging different parts of speech from the segmented words using text tokenization, wherein word correction is performed on the segmented words as part for obtaining the tokenized data; and
remove stop words from the tokenized data to obtain the dean data.

19. The non-transitory computer-readable medium of claim 16, wherein to obtain the dean data, the processor is to:
extract clickstream data, web search data, or a combination thereof from the real-time data to obtain extracted data;
generate key performance indicators from the extracted data based on deep learning techniques; and
perform click stream analytics based on the key performance indicators to obtain the dean data.

20. The non-transitory computer-readable medium of claim 15, wherein the processor is to:
obtain real-time and historical time series data related to the plurality of similar products;
create an ensemble model using the real-time and historical time series data to provide a composite volume for each of the plurality of similar products to ascertain a real-time demand forecast of the product, the real-demand being indicative of the sale of the product and impact on the cannibalization volume.
